(19) United States
(12) Patent Application Publication
(10) Pub. No.: US 2020/0044230 A1
(43) Pub. Date: Feb. 6, 2020

(54) METHOD FOR MANUFACTURING ELECTRODE FOR RECHARGEABLE BATTERY

(71) Applicant: LG CHEM, LTD., Seoul (KR)

(72) Inventors: Jin Young SON, Daejeon (KR); Moo Yong SHIN, Daejeon (KR); Sang Hoon CHOY, Daejeon (KR); Jung Min YANG, Daejeon (KR); Taek Soo LEE, Daejeon (KR); Do Hyun LEE, Daejeon (KR); Chan Soo JUN, Daejeon (KR); Cheol Woo KIM, Daejeon (KR)

(73) Assignee: LG CHEM, LTD., Seoul (KR)

(21) Appl. No.: 16/494,969

(22) PCT Filed: Oct. 22, 2018
(86) PCT No.: PCT/KR2018/012498

§ 371 Date: Sep. 17, 2019

(30) Foreign Application Priority Data
Oct. 31, 2017 (KR) 10-2017-0144121

(51) Int. Cl. H01M 4/04; H01M 4/139; B21D 28/02

(52) U.S. Cl. CPC H01M 4/0404; B21D 28/02; H01M 4/139; H01M 4/0435

(57) ABSTRACT

A method for manufacturing an electrode for a rechargeable battery includes, with reference to a center axis that divides a metal sheet left and right, setting a first coating line that is parallel with the center axis at a location deflected to one side, and a second coating line that is parallel with the center axis at a location deflected to the other side so as to correspond to the first coating line with reference to the virtual center axis and coating an electrode slurry on the metal sheet while alternately moving a slot die to the first coating line and the second coating line.

### CROSS-REFERENCE TO RELATED APPLICATION

### Technical Field

This application claims priority to and the benefit of Korean Patent Application No. 10-2017-0144121 filed in the Korean Intellectual Property Office on Oct. 31, 2017, the entire contents of which are incorporated herein by reference.

The present invention relates to a method for manufacturing a rechargeable battery electrode.

### Background Art

Recently, as technology development and demand for mobile devices has grown, demands for a rechargeable battery as an energy source that can be charged/discharged have been rapidly increased, and such a rechargeable battery essentially includes an electrode assembly, which is an electricity generation element.

The electrode assembly is formed by assembling a positive electrode, a separation membrane, and a negative electrode in a predetermined shape, wherein the positive electrode and the negative electrode are plate-shaped electrodes, of which a positive electrode slurry and a negative electrode slurry, each including an active material, are coated on current collectors, each formed of an electrically conductive metal foil, and then dried.

A process for manufacturing the plate-shaped electrode may include a process for manufacturing an electrode mixture that contains an electrode active material, a process for manufacturing an electrode sheet by coating the electrode mixture on a metal foil, a process for forming an electrode tab on an electrode, a process for rolling electrodes, and a process for manufacturing unit electrodes by notching the electrodes into a desired shape and size.

The process for manufacturing the electrode sheet is illustrated in FIG. 1.

Referring to FIG. 1, in the electrode sheet manufacturing process 10, a metal sheet 50 that moves by a re-winder 40 is set to contact a slot die coater 20 that discharges an electrode slurry, and then the electrode slurry is coated on the metal sheet 50 while forming a line 52. Such an electrode line 52 may be singular, or maybe two or more formed by repeating several coating processes.

The metal sheet 50 in which the electrode lines 52 are formed is notched into a desired shape and size such that a single unit electrode can be manufactured.

Meanwhile, the rechargeable batteries may be manufactured in an atypical geometric design, which is different from a known rectangular or cylindrical structure, so that they may be applied to products that are diversified and may be applicable to various devices having curved line or curved surfaces.

As an example of the atypical design, recently, an irregular-shaped battery having a polygonal structure in which some portions are missed in a long direction has been attracting attention so as to be applicable to a slim or curved type of device, or a variety of device designs, and an electrode is also manufactured with the irregular-shaped structure for realization of the same.

However, when the metal sheet shown in FIG. 2, is notched with a polygonal structure that corresponds to a cut line C as an example of such an irregular-shape, part (54) of the electrode line 52 not included in the irregular shape is abandoned, and thus expensive raw materials such as an electrode active material, a binder, and a solvent of the electrode slurry, which are the main components of the electrode line 52, are wasted.

This is a cause of an increase in the manufacturing cost of the irregular-shaped electrode and the rechargeable battery including the same. Therefore, there is a need for a technique for solving the increase of the manufacturing cost.

### DISCLOSURE

### Technical Problem

An object of the present invention is to solve the problem of the related art as described above and a technical problem required from the past.

Specifically, an object of the present invention is designed to provide a method for manufacturing an electrode for a rechargeable battery, the method including coating an electrode line for minimizing an amount of electrode slurry that is unnecessary wasted while manufacturing the electrode for the rechargeable battery with a desired irregular shape, and notching the electrode line into an irregular shape.

### Technical Solution

A method for manufacturing a rechargeable battery for achieving such an object includes:

with reference to a virtual center axis that divides a metal sheet into left and right, setting a first coating line that is parallel with the center axis at a location deflected to one side, and a second coating line that is parallel with the center axis at a location deflected to the other side so as to correspond to the first coating line with reference to the virtual center axis; and

coating an electrode slurry on the metal sheet while alternately moving a slot die to the first coating line and the second coating line.

Thus, according to the method of the present invention, the slot die that is alternately disposed in the first coating line and the second coating line may coat an electrode line in a zigzag shape, and thus the electrode line includes an irregular shape including an uncoated region, thereby saving an amount of electrode slurry that would be be coated on the uncoated region.

The first coating line is set at a location that is separated from one end portion in a width direction of the metal sheet with a length that is more than 10% to less than 50%, particularly, a length that is more than 10% to less than 30%, and more particularly, a length that is more than 10% to less than 20%, with respect to the width of the metal sheet, and

the second coating line is set at a location that is separated from the other end portion in the width direction of the metal sheet with a length that is more than 10% to less than 50%, particularly, a length that is more than 10% to less than 30%, and more particularly, a length that is more than 10% to less than 20%, with respect to the width of the metal sheet.

In such a structure, a margin portion is formed between the first coating line and an end of the metal sheet, and the margin portion is processed into a predetermined shape, thereby forming an electrode tab.

Similarly, a margin portion is formed between the second coating line and an end of the metal sheet, and the margin portion is processed into a predetermined shape, thereby forming an electrode tab.

In one specific example, the coating of the electrode slurry on the metal sheet may include:

producing a first state in which one end of the slot die is located in the first coating line and the electrode slurry is coated along the first coating line; and

producing a second state in which the other end of the slot die is located in the second coating line and the electrode slurry is coated along the second coating line, and

in the first state and the second state, a side end of the slot die that is not located in any of the first coating line and the second coating line is located in third coating lines that are parallel with the first coating line and the second coating line, and are respectively set at opposite ends of the metal sheet.

In addition, in the method for manufacturing the electrode for the rechargeable battery, the slot die may be set to alternate between the first state and the second state,

a first electrode line may be formed between the first coating line and the second coating line in both of the first state and the second state,

a second electrode line may be formed between the second coating line and the third coating line that is adjacent to the second coating line in the first state, and

a third electrode line may be formed between the first coating line and the third coating line that is adjacent to the first coating line in the second state.

In this case, a first uncoated portion, which is an uncoated region having the first coating line as a boundary, may be set in the third electrode line in the first state, and

a second uncoated portion, which is an uncoated region having the second coating line as a boundary, may be set in the second electrode line in the second state.

Depending on cases, after forming electrode lines, the method may further include rolling and drying the first electrode line, the second electrode line, and the third electrode line.

The method for manufacturing the electrode for the rechargeable battery according to the present invention may further include forming an irregular-shaped electrode by notching the metal sheet with:

a first shape that includes at least a part of the third electrode line, excluding the first uncoated portion, and at least a part of the first electrode line; and

a second shape that includes at least a part of the second electrode line, excluding the second uncoated portion, and at least a part of the first electrode line, and

notching with respect to the first shape and notching with respect to the second shape may be respectively carried out with reference to a virtual line that equally divides the first electrode line between boundaries of the first electrode line.

That is, since the method for manufacturing the electrode for the rechargeable battery includes notching while excluding an uncoated region where the electrode slurry does not exist, and thus the amount of electrode slurry wasted during the notching can be minimized, and waste of expensive organic/inorganic material such as an electrode active material, a binder, a solvent, and a conductive material, which form the electrode slurry, can be prevented.

Each of the first shape and the second shape may include:

a first electrode portion derived from the first electrode line; and

a second electrode portion derived from the second electrode line or the third electrode line, and extended from the first electrode portion and having a size that is smaller than the first electrode portion such that at least one step difference is formed on a plane, and

the metal sheet may be notched into the first shape and the second shape with different electrodes that form the first shape and the second shape.

That is, the first electrode portion having a relatively large size and the second electrode portion having a relatively small size form a step difference such that an electrode having an irregular shape can be manufactured.

The step difference may include a step difference corner that is formed in a portion where an exterior side of the first electrode portion and an exterior side of the second electrode portion cross each other at an angle of more than 30 degrees and less than 180 degrees, and

in the step difference corner, the metal sheet may be additionally notched such that a part of each of the first electrode portion and the second electrode portion are inwardly recessed such that an exterior circumference recess portion may be formed.

One or more step differences may be included depending on setting of a notching range, and accordingly, an irregular-shape electrode having various polygonal structures may be manufactured.

Specifically, two or fewer step difference corners may be included, and more specifically, only one step difference corner may be included.

Meanwhile, in FIG. 3, a schematic view of a battery cell that includes an irregular-shaped electrode according to a prior art is illustrated.

Referring to FIG. 3, a battery cell 100 is formed with a structure in which exterior sides 121, 122, 123, and 124 of a cell case 120 are thermally bonded while an electrode assembly 110 is installed in the cell case 120, together with an electrolyte solution.

Specifically, the electrode assembly 110 is divided into two electrode portions 110a and 110b, each having a different planar shape and size with respect to the ground, with reference to a boundary A, and accordingly, a step difference 130 formed due to the size difference between the electrode portions 110a and 110b is formed in the electrode assembly 110. In addition, the cell case 120 is formed with a shape that corresponds to the electrode assembly 110, and the exterior sides 121, 122, 123, and 124 are sealed along end portions of the electrode assembly 110 such that the battery cell 100 is formed with an irregular-shaped structure including the step difference 130 corresponding to the shape of the electrode assembly 110 rather than being formed with a conventional rectangular shape.

However, in the structure of the battery cell 100 shown in FIG. 3, since different exterior sides 121 and 122 of the cell case 120 also cross each other so as to correspond to the shape of exterior circumferential corners C, which are portions where exterior sides of the electrode portions 110a and 110b intersect each other, a relatively wide sealing area is formed at the portion where the exterior sides 121 and 122 intersect each other.

In addition, since the portion where the exterior sides 121 and 122 share the sealing portion while intersecting each other has relatively lower sealing force compared to other portions, a relatively wider thermally bonded sealing area than that of the other exterior sides 123 and 124 is required at the exterior sides 121 and 122 of the cell case 120, which are adjacent to the exterior corner C.

Accordingly, the structure of the battery cell 100 is disadvantageous in that space utilization of the device is decreased by as much as the sealing area that is unnecessarily occupied by the exterior sides 121 and 122 in the exterior corner C.

In addition, excluding the exterior side 124 where electrode leads 101 and 102 are formed, each of the exterior sides 121, 122, and 123 that are sealed by thermal bonding in the cell case 120 needs to be bent to a side direction of the electrode assembly 110 so as to prevent moisture permeation therethrough and reduce the area of the battery cell, but in the structure shown in FIG. 3, the exterior sides 121 and 122 of the cell case 120, which are adjacent to the exterior corner C, are connected with each other corresponding to the exterior corner C, and thus the exterior sides 121 and 122 cannot be easily bent to the side surface of the electrode assembly 110.

When a portion where the exterior sides 121 and 122 are connected is cut for bending, a sealing area of the cell case 120 between the exterior corner C and a cut portion is not secured, thereby causing the sealing state to not be secured.

Accordingly, in the present invention, an irregular-shaped electrode for a rechargeable battery, in which an exterior circumference recess portion is formed at a portion where a first electrode portion and a second electrode portion cross each other, is manufactured, and in a battery cell including such an irregular-shaped electrode, a cell case is additionally sealed by thermal bonding at the exterior circumference recess portion, thereby improving sealing reliability.

The external circumference recess portion may have a rounded structure including curved lines, a complex structure in which curved lines and straight lines are connected, or a polygonal structure in which a plurality of straight lines are connected, in a plan view.

The method for manufacturing the irregular-shaped electrode may further include notching to form an electrode tab that externally protrudes from at least one of the first electrode portion and the second electrode portion.

In method for manufacturing the irregular-shaped electrode, notching may be additionally carried to chamfer the corners of at least one of the first electrode portion and the second electrode portion.

The irregular-shape electrode defined by the present invention may be a positive electrode or a negative electrode.

The positive electrode is manufactured by, for example, coating a mixture of a positive electrode active material, a conductive material, and a binder on a positive electrode current collector and/or an extension current collecting part, and drying it, and if required, further adding a filler to the mixture.

The positive electrode current collector and/or the extension current collecting part are/is generally manufactured to have a thickness of 3 to 500 μm. The positive electrode current collector and the extension current collecting part are not particularly limited as long as they do not cause a chemical change in the battery and have high conductivity, and for example, stainless steel, aluminum, nickel, titanium, fired carbon, or aluminum or stainless steel of which the surface is treated with carbon, nickel, titanium, silver, and the like, may be used. The positive electrode current collector and the extension current collecting part may increase adhesion of the positive electrode active material by forming fine protrusions and depressions on the surfaces thereof, and may be formed in various forms such as a film, a sheet, foil, a net, a porous body, a foam, a non-woven fabric body, and the like.

The positive electrode active material may include layered compounds or compounds substituted with one or more transition metals such as lithium cobalt oxide (LiCoO₂) and lithium nickel oxide (LiNiO₂); lithium manganese oxides such as those with the chemical formula Li₁+xMn₂-xO₄ (wherein x is 0-0.33), LiMnO₃, LiMn₂O₃, LiMnO₂, and the like; lithium copper oxide (Li₂CuO₂); vanadium oxides such as LiV₃O₅, LiFe₃O₄, V₂O₅, and Cu₂V₂O₇; Ni-site type lithium nickel oxides represented by the chemical formula LiNi1-xMxO₂ (wherein M=Co, Mn, Al, Cu, Fe, Mg, B, or Ga, and x=0.01-0.3); lithium manganese composite oxides represented by the chemical formula LiMn₂-xMxO₂ (wherein M=Co, Ni, Fe, Cr, Zn, or Ta, and x=0.01-0.1) or Li₂Mn₃MO₅ (wherein M=Fe, Co, Ni, Cu, or Zn); LiMn₂O₄ in which Li is partially substituted with an alkaline-earth metal ion in the chemical formula; a disulfide compound; Fe₂(MoO₄)₃; and the like, but are not limited thereto.

The conductive material is usually added at 1 to 30 wt %, based on the total weight of the mixture including the positive electrode active material. This conductive material is not particularly limited as long as it does not cause a chemical change in the battery and has conductivity, and for example, graphite such as natural graphite or artificial graphite; carbon black, acetylene black, ketjen black, channel black, furnace black, lamp black, and summer black; a conductive fiber such as carbon fiber or metal fiber; a metal powder such as fluorocarbon, aluminum, and nickel powder; conductive whiskers such as zinc oxide and potassium titanate; conductive metal oxides such as titanium oxide; conductive materials such as polyphenylene derivatives; and the like may be used.

The binder is a component assisting in binding the active material to the conductive material and the like, and binding to the current collector, and is generally added at 1 to 30 wt %, based on the total weight of the mixture including the positive electrode active material. As an example of this binder, polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, an ethylene-propylene-diene terpolymer (EPDM), sulfonated EPDM, styrene butylene rubber, fluorine rubber, various copolymers, and the like may be listed.

The filler is a component suppressing expansion of the positive electrode, and is optionally used. It is not particularly limited as long as it does not cause a chemical change in the battery and is a fibrous material, and for example, olefin-based polymers such as polyethylene and polypropylene, and fibrous materials such as glass fiber and carbon fiber, may be used.

The negative electrode is manufactured by coating a negative electrode active material on the negative electrode current collector and/or the extension current collecting part, and drying it, and if necessary, the components as described above may be optionally further included.

The negative electrode current collector and/or the extension current collecting part are/is generally manufactured to have a thickness of 3 to 500 μm. The positive electrode current collector and an extended current collector part are not particularly limited as long as they do not cause a chemical change in the battery and have high conductivity, and for example, stainless steel, aluminum, nickel, titanium, sintered carbon, or aluminum or stainless steel which are surface-treated with carbon, nickel, titanium, silver, or the like, and the like, may be used. The positive electrode current collector and the extended current collector part may have fine protrusions and depressions formed on the surface to increase adherence of the positive electrode active material, and may be formed into various forms such as a film, a sheet, foil, a net, a porous body, a foam, and a non-woven fabric body.

As the negative electrode active material, for example, carbons such as hard carbon and graphite-based carbon; metal composite oxides such as LixFe₂O₃ (0≤x≤1), LixWO₂ (0≤x≤1), SnxMe1-xMe′yOz (Me: Mn, Fe, Pb or Ge; Me′: Al, B, P, Si, an element of Group 1, 2, or 3 of the periodic table, or a halogen; 0<x≤1; 1≤y≤3; 1≤z≤8); a lithium metal; a lithium alloy; a silicon-based alloy; a tin-based alloy; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li-Co-Ni-based materials; and the like may be used.

### DESCRIPTION OF THE DRAWINGS

FIG. 1 is a schematic view of an electrode manufacturing method according to a conventional method.

FIG. 2 is a plan schematic view of an electrode sheet coated with an electrode slurry according to a prior art.

FIG. 3 is a schematic view of an irregular-shaped battery cell according to a prior art.

FIG. 4 is a flowchart of a manufacturing method according to one exemplary embodiment of the present invention.

FIG. 5 and FIG. 6 are schematic views of a process for coating an electrode slurry on a metal sheet according to the exemplary embodiment of the present invention.

FIG. 7 is a schematic view of a process for notching the metal sheet coated with the electrode slurry into an irregular shape according to the exemplary embodiment of the present invention.

FIG. 8 is a schematic plan view of an irregular-shaped electrode for a rechargeable battery according to the exemplary embodiment of the present invention.

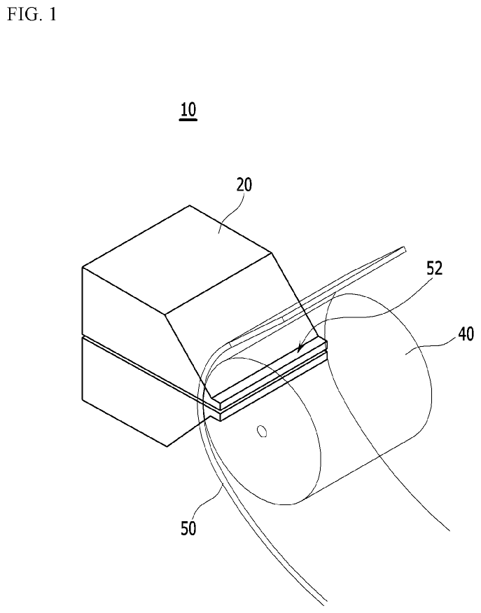

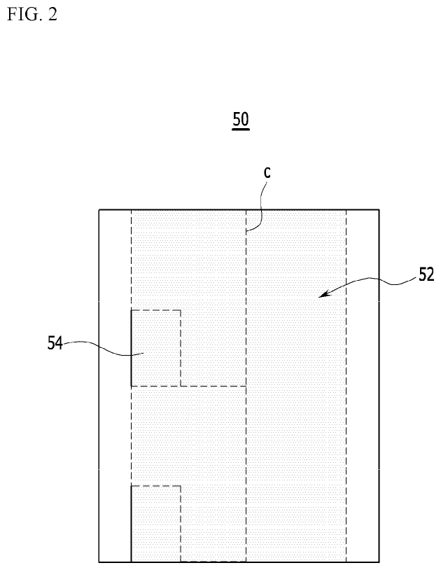

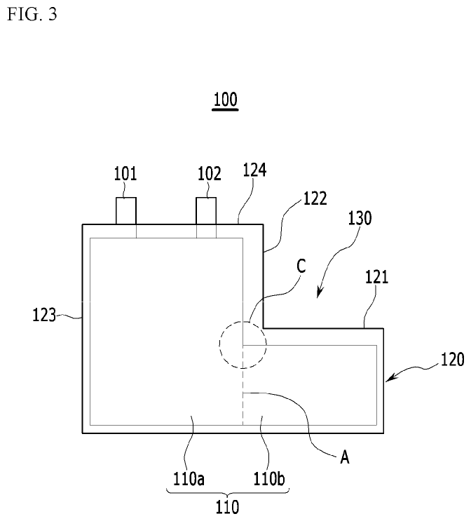

### MODE FOR INVENTION

Hereinafter, the exemplary embodiments of the present invention will be described in detail, referring to the accompanying drawings. However, in the description of the present disclosure, descriptions for already known functions or components will be omitted for clarifying the present disclosure.

In order to clearly describe the present disclosure, parts which are not related to the description are omitted, and the same reference numerals refer to the same or like components, throughout the specification. In addition, since the size and the thickness of each component shown in the drawing are arbitrarily represented for convenience of the description, the present disclosure is not limited to the illustration.

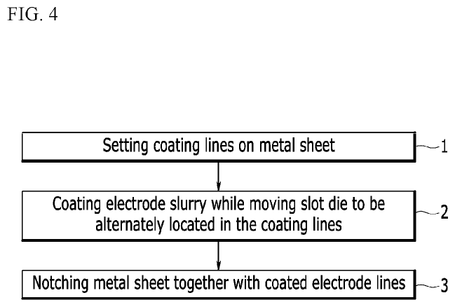

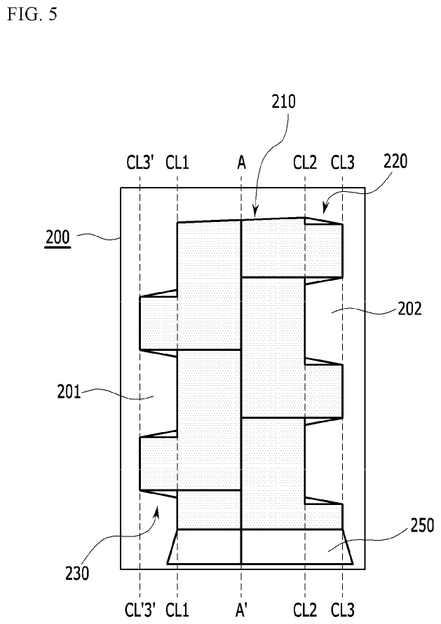

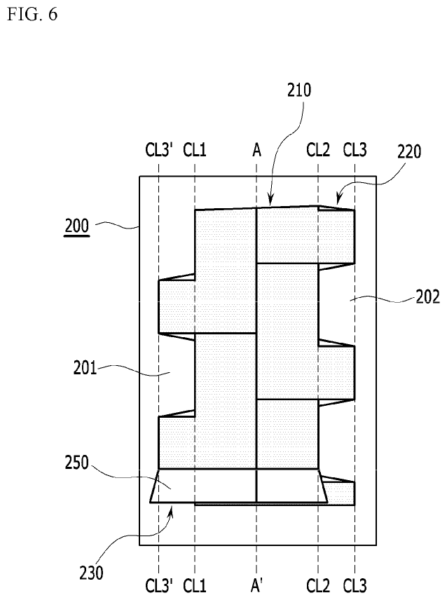

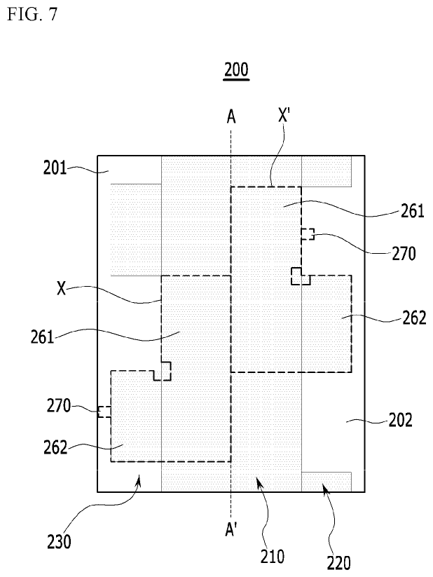

FIG. 4 is a flowchart of a method for manufacturing an electrode for a rechargeable battery according to an exemplary embodiment of the present invention, FIG. 5 and FIG. 6 are schematic views of a process for coating an electrode slurry on a metal sheet, and FIG. 7 is a schematic view of a process for notching the metal sheet.

Referring to the drawings, a manufacturing method according to the present invention may include a process 1 for setting coating lines on a metal sheet, a process 2 for coating an electrode slurry while moving a slot die to be alternately located on predetermined coating lines, and a process 3 for notching the metal sheet together with the electrode lines into a predetermined shape.

First, in the process 1, with reference to a virtual center axis A-A′ that divides a metal sheet 200 to the left and right, a first coating line CL1 that is parallel with the central axis may be set at a location deflected to one side.

In addition, with reference to the virtual center axis A-A′, a second coating line CL2 that is parallel with the center axis A-A′ at a location that is deflected to the other side may be set corresponding to the first coating line CL1.

Next, the process 2 is carried out. In the process 2, the electrode slurry is coated on the metal sheet 200 while moving a slot die 250 in which the electrode slurry is loaded to be alternately located at the first coating line CL1 and the second coating line CL2.

The process 2 is a step that includes producing a first state of FIG. 5 and a second state of FIG. 6, and during which the first state and the second state are alternately produced.

Here, as shown in FIG. 5, the first state implies a state in which one side of the slot die 250 is located in the first coating line CL1, and the electrode slurry is coated along the first coating line CL1.

The second state implies a state in which the other end of the slot die 250 is located in the second coating line CL2, and the electrode slurry is coated along the second coating line CL2.

A side end of the slot die 250, which is not located in either of the first coating line CL1 or the second coating line CL2 in the first state and the second state is located between third coating lines CL3 and CL3′ that are parallel with the first coating line CL1 and the second coating line CL2.

That is, the third coating lines CL3 add CL3′ are coating lines that are additionally set at opposite ends of the metal sheet 200. Depending on cases, the third coating lines CL3 and CL3′ may be set while simply moving the slot die 250 in the process 1.

However, the slot die 250 discharges the electrode slurry between the first coating line CL1 and the second coating line CL2 in any state, and accordingly, a first electrode line 210 can be formed between the first coating line CL1 and the second coating line CL2 in the first state and the second state.

In the first state, one end of the slot die 250 is deflected over the second coating line CL2 such that a second electrode line 220 may be formed between the second coating line CL2 and the third coating line CL3 that is adjacent to the second coating line CL2. Simultaneously, a first uncoated portion 201, which is an coated region while having the first coating line CL1 as a boundary may be set in a third electrode line 230, which will be described later.

On the contrary, when the other end of the slot die 250 is deflected over the first coating line CL1, the third electrode line 230 may be formed between the first coating line CL1 and the third coating line CL3′ that is adjacent to the first coating line CL1. Simultaneously, a second uncoated portion 202, which is an uncoated region while having the second coating line CL2 as a boundary, may be set in a second electrode line 220, which will be described later.

After such a coating process, rolling and drying the first electrode line 210, the second electrode line 220, and the third electrode line 230 may be carried out.

Next, the process 3 is carried out. In the process 3, the metal sheet 200 is notched with a first shape X that includes at least part of the third electrode line 230, excluding the first uncoated portion 201 and a part of the first electrode line 210, and a second shape X′ that includes at least a part of the second electrode line 220, excluding the second uncoated portion 202 and a part of the first electrode line 210, which does not overlap the first shape X such that an irregular-shaped electrode can be formed.

In this case, the first shape X and the second shape X1 may be respectively notched with reference to the virtual line A-A′ that equally divides the first electrode line 210 between the boundaries of the first electrode line 210.

In FIG. 7, when the notching is carried out, one stepped corner is included, but one or more stepped corners may be included depending on a range of the notching, and accordingly, an irregular-shaped electrode having various polygonal structures may be manufactured.

In addition, in the process 3, notching for forming an electrode tab 270 that protrudes to the outside from a second electrode portion 262 may be additionally carried out. However, depending on a desired shaped of the irregular-shaped electrode, notching that forms an electrode tab 270 that protrudes to the outside from a first electrode portion 261 may be carried out.

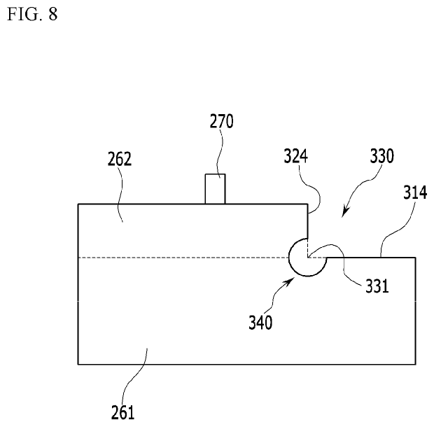

FIG. 8 is a schematic view of an irregular-shaped electrode according to an exemplary embodiment of the present invention, and an irregular-shaped electrode notched in the process 3 will be described in detail with reference to FIG. 8, together with FIG. 7.

Referring to the drawings, the first shape X and the second shape X′ respectively have an irregular-shaped polygonal structure on a plane, each including one step difference corner.

Specifically, the first shape X and the second shape X′ may respectively include a first electrode portion 261 derived from the first electrode line 210, and a second electrode portion 262 derived from the second electrode line 220 and the third electrode line 230 and extended from the first electrode portion 261 while having a size that is smaller than the first electrode portion 261 such that at least one step difference (refer to 330 of FIG. 8) is formed on a plane.

Here, the step difference 330 includes a step difference corner 331 that is formed at a portion where an exterior side 314 of the first electrode portion 261 and an exterior side 324 of the second electrode portion 262 intersect each other at about 90 degrees, and in the notching of the process 3, notching may be additionally carried out to form an exterior circumference recess portion 340 having a shape formed by inwardly recessing a part of the first electrode portion 261 and a part of the second electrode portion 262.

Hereinbefore, the certain exemplary embodiments of the present invention have been described and illustrated, however, it is apparent to a person with ordinary skill in the art that the present invention is not limited to the exemplary embodiments as described, and may be variously modified and transformed without departing from the spirit and scope of the present invention. Accordingly, the modified or transformed exemplary embodiments as such are not to be understood separately from the technical ideas and aspects of the present invention, and the modified exemplary embodiments are within the scope of the claims of the present invention.

### INDUSTRIAL APPLICABILITY

As described above, according to the method for manufacturing an electrode for a rechargeable battery according to the exemplary embodiments of the present invention, a slot die that is alternately disposed in the first coating line and the second coating line may coat an electrode line in a zigzag shape, and thus the electrode line includes an irregular shape including an uncoated region, thereby saving an amount of electrode slurry that would be coated on the uncoated region.

In addition, since notching is carried out excluding the uncoated region where the electrode slurry is not coated, the amount of slurry wasted during the notching can be minimized, thereby preventing waste of expensive organic/inorganic materials such as an electrode active material, a binder, a solvent, and a conductive material.

1. A method for manufacturing an electrode for a rechargeable battery, comprising:
with reference to a center axis that divides a metal sheet left and right, setting a first coating line that is parallel with the center axis at a location to the left of the center axis, and a second coating line that is parallel with the center axis at a location to the right of the center axis so as to correspond to the first coating line with reference to the center axis; and
coating an electrode slurry on the metal sheet while laterally moving a slot die between the first coating line and the second coating line.

2. The method for manufacturing the electrode for the rechargeable battery of claim 1, wherein the first coating line is set at a location that is separated from a left edge of the metal sheet by a distance that is more than 10% to less than 50% of a width of the metal sheet, and
the second coating line is set at a location that is separated from a right edge of the metal sheet by a distance that is more than 10% to less than 50% with respect to the width of the metal sheet.

3. The method for manufacturing the electrode for the rechargeable battery of claim 1, wherein the coating of the electrode slurry on the metal sheet comprises:
producing a first state in which a left edge of the slot die is located on the first coating line and the electrode slurry is coated along the first coating line; and
producing a second state in which a right edge of the slot die is located on the second coating line and the electrode slurry is coated along the second coating line, and
in the first state and the second state, the edge of the slot die that is not located on either of the first coating line and the second coating line is located on one of a third coating line that is parallel with the first coating line and the second coating line, and are respectively set at opposite ends of the metal sheet.

4. The method for manufacturing the electrode for the rechargeable battery of claim 3, wherein the slot die is set to alternate between the first state and the second state,
a first electrode line is formed between the first coating line and the second coating line in both of the first state and the second state,
a second electrode line is formed between the second coating line and the third coating line that is adjacent to the second coating line in the first state, and
a third electrode line is formed between the first coating line and the third coating line that is adjacent to the first coating line in the second state.

5. The method for manufacturing the electrode for the rechargeable battery of claim 4, wherein a first uncoated portion, which is an uncoated region having the first coating line as a boundary is set in the third electrode line in the first state, and a second uncoated portion, which is an uncoated region having the second coating line as a boundary is set in the second electrode line in the second state.

6. The method for manufacturing the electrode for the rechargeable battery of claim 5, further comprising forming an irregular-shaped electrode by notching the metal sheet with:
a first shape that includes at least a part of the third electrode line, excluding the first uncoated portion, and at least a part of the first electrode line; and
a second shape that includes at least a part of the second electrode line, excluding the second uncoated portion, and at least a part of the first electrode line,
wherein notching with respect to the first shape and notching with respect to the second shape are respectively carried out with reference to a virtual line that equally divides the first electrode line between boundaries of the first electrode line.

7. The method for manufacturing the electrode for the rechargeable battery of claim 6, wherein each of the first shape and the second shape comprises:
a first electrode portion derived from the first electrode line; and
a second electrode portion derived from the second electrode line or the third electrode line, and extended from the first electrode portion and having a size that is smaller than the first electrode portion such that at least one step difference is formed on a plane, and
the metal sheet is notched into the first shape and the second shape with different electrodes that form the first shape and the second shape.

8. The method for manufacturing the electrode for the rechargeable battery of claim 7, wherein the step difference comprises a step difference corner that is formed in a portion where an exterior side of the first electrode portion and an exterior side of the second electrode portion cross each other at an angle of more than 30 degrees and less than 180 degrees, and
in the step difference corner, the metal sheet is additionally notched such that a part of each of the first electrode portion and the second electrode portion are inwardly recessed such that an exterior circumference recess portion is formed.

9. The method for manufacturing the electrode for the rechargeable battery of claim 8, wherein the exterior circumference recess portion comprises, on a plane:
a rounded structure including a curved line;
a complex structure in which a curved line and a straight line are connected; or
a polygonal structure in which a plurality of straight lines are connected.

10. The method for manufacturing the electrode for the rechargeable battery of claim 8, wherein the step difference comprises one or more of the step difference corners.

11. The method for manufacturing the electrode for the rechargeable battery of claim 10, wherein the step difference comprises only one step difference corner.

12. The method for manufacturing the electrode for the rechargeable battery of claim 7, wherein notching is additionally carried out to form an electrode tab that externally protrudes from at least one of the first electrode portion and the second electrode portion.

13. The method for manufacturing the electrode for the rechargeable battery of claim 7, wherein notching is additionally carried to chamfer the corners of at least one of the first electrode portion and the second electrode portion.

14. The method for manufacturing the electrode for the rechargeable battery of claim 6, further comprising rolling and drying the first electrode line, the second electrode line, and the third electrode line.
